(19) United States
(12) Patent Application Publication
(10) Pub. No.: US 2003/0217043 A1
(43) Pub. Date: Nov. 20, 2003

(54) Method and system for storing field replaceable unit dynamic information using tagged data elements

(75) Inventors: Steven E. Weiss, San Mateo, CA (US); Raymond J. Gilstrap, Milpitas, CA (US); Robert Abramovitz, Belmont, CA (US); David S. Gordon, Farnborough (GB); Gregory S. Jumper, Menlo park, CA (US); Daniel J. Hain, Poway, CA (US); Fongyan Gang, San Diego, CA (US)

Correspondence Address: Lawrence J. Merkel, Meyertons, Hood, Kivlin, Kowert & Goetzel, P.C., P.O. Box 398, Austin, TX, 78767, US

(73) Assignee: Sun Microsystems, Inc., Santa Clara, CA

(21) Appl. No.: 10/413,170

(22) Filed: Apr. 14, 2003

Related U.S. Application Data
(60) Provisional application No. 60/381,400, filed on May 17, 2002.
(60) Provisional application No. 60/381,116, filed on May 17, 2002.
(60) Provisional application No. 60/381,386, filed on May 17, 2002.
(60) Provisional application No. 60/381,131, filed on May 17, 2002.

(51) Int. Cl. G06F 7/00

(52) U.S. Cl. 707/2

(57) ABSTRACT

A method includes providing a field replaceable unit having a memory device. A first data element including dynamic information associated with the service life of the field replaceable unit is generated. A first tag is generated for the first data element. The first tag is prepended to the first data element to generate a first tagged data element. The first tagged data element is stored in the memory device. A computing system includes a field replaceable unit having a memory device configured to store a first tagged data element, the first tagged data element including a first data element including dynamic information associated with the service life of the field replaceable unit and a first tag associated with the first data element.

This patent application claims benefit of priority to U.S. Provisional Patent Application Serial No. 60/381,400, filed May 17, 2002. This patent application claims benefit of priority to U.S. Provisional Patent Application Serial No. 60/381,116, filed May 17, 2002. This patent application claims benefit of priority to U.S. Provisional Patent Application Serial No. 60/381,386, filed May 17, 2002. This patent application claims benefit of priority to U.S. Provisional Patent Application Serial No. 60/381,131, filed May 17, 2002. The above applications are incorporated herein by reference in their entireties.

### BACKGROUND OF THE INVENTION

1. Field of the Invention

This invention relates generally to a processor-based computer system and, more particularly, to a method and system for storing field replaceable unit dynamic information using tagged data elements.

2. Description of the Related Art

The last several years have witnessed an increased demand for network computing, partly due to the emergence of the Internet. Some of the notable trends in the industry include a boom in the growth of Applications Service Providers (ASPs) that provide applications to businesses over networks and enterprises that use the Internet to distribute product data to customers, take orders, and enhance communications with employees.

Businesses typically rely on network computing to maintain a competitive advantage over other businesses. As such, developers, when designing processor-based systems for use in network-centric environments, may take several factors into consideration to meet the expectation of the customers, factors such as the functionality, reliability, scalability, and performance of such systems.

One example of a processor-based system used in a network-centric environment is a mid-frame server system. Typically, mid-frame servers are employed in high bandwidth systems requiring high availability factors. Minimizing system downtime is an important system management goal, as downtime generally equates to significant lost revenue. Typically, such computer systems are provided with replaceable components or modules that may be removed and/or installed without shutting down the system. This on-line replacement capability is commonly referred to as a hot-pluggable or hot-swappable environment.

Unlike current desktop computer systems, in which the internal cards and devices are essentially disposable (i.e., they are replaced if they fail, and the defective part is discarded without repair), the individual components used to construct higher end systems, such as the mid-frame server described above, are typically returned to the manufacturer or a third-party vendor associated with the manufacturer for repair. Repaired units are then reinstalled in the same or in a different mid-frame server. Such repairable components are commonly referred to as field replaceable units (FRUs). In the service life of a particular FRU, it may be installed in multiple servers owned by different customers. Exemplary units that may be field replaceable are system control boards, processing boards, memory modules installed on one of the processing boards, input/output (I/O) boards, power supplies, cooling fans, and the like.

Throughout the service life of a particular FRU, it may be serviced by different repair entities and installed in different customer facilities. Because of the different entities involved during the service life of the FRU, it is difficult to maintain accurate and retrievable records for the individual FRUs. Different databases including information about the FRU may not be centralized or even available.

### SUMMARY OF THE INVENTION

One aspect of the present invention is seen in a method including providing a field replaceable unit having a memory device. A first data element including dynamic information associated with the service life of the field replaceable unit is generated. A first tag is generated for the first data element. The first tag is prepended to the first data element to generate a first tagged data element. The first tagged data element is stored in the memory device.

Another aspect of the present invention is seen in a computing system includes a field replaceable unit having a memory device configured to store a first tagged data element, the first tagged data element including a first data element including dynamic information associated with the service life of the field replaceable unit and a first tag associated with the first data element. A controller may be provided for tagging and storing the first data element in the memory device.

### BRIEF DESCRIPTION OF THE DRAWINGS

The invention may be understood by reference to the following description taken in conjunction with the accompanying drawings, in which like reference numerals identify like elements, and in which:

FIG. 1 is a simplified block diagram of a system in accordance with one embodiment of the present invention;

FIG. 2 is a diagram of a field replaceable unit identification (FRUID) memory;

FIG. 3 is a simplified block diagram illustrating a field replaceable unit (FRU) having a plurality of submodules;

FIG. 4 is a simplified block diagram of a format used to store data in the FRUID memory of FIG. 2; and

FIG. 5 is a simplified flow diagram of a method for storing information for a field replaceable unit in accordance with another embodiment of the present Invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will, of course, be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, and/or magnetic signals capable of being stored, transferred, combined, compared, and otherwise manipulated. It has proven convenient at times, principally for reasons of common usage, to refer to these signals as bits, values, elements, symbols, characters, terms, numbers, and the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” and the like, refer to the action and processes of a computer system, or similar electronic computing device, that manipulates and transforms data represented as physical, electronic quantities within the computer system's registers and/or memories into other data similarly represented as physical quantities within the computer system memories and/or registers and/or other such information storage, transmission and/or display devices.

The programming instructions necessary to implement these software functions may be resident on various storage devices. Such storage devices referred to in this discussion may include one or more machine-readable storage media for storing data and/or instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, and/or modules in the various systems may be stored in respective storage devices. The instructions, when executed by a respective control unit, cause the corresponding system to perform programmed acts as described.

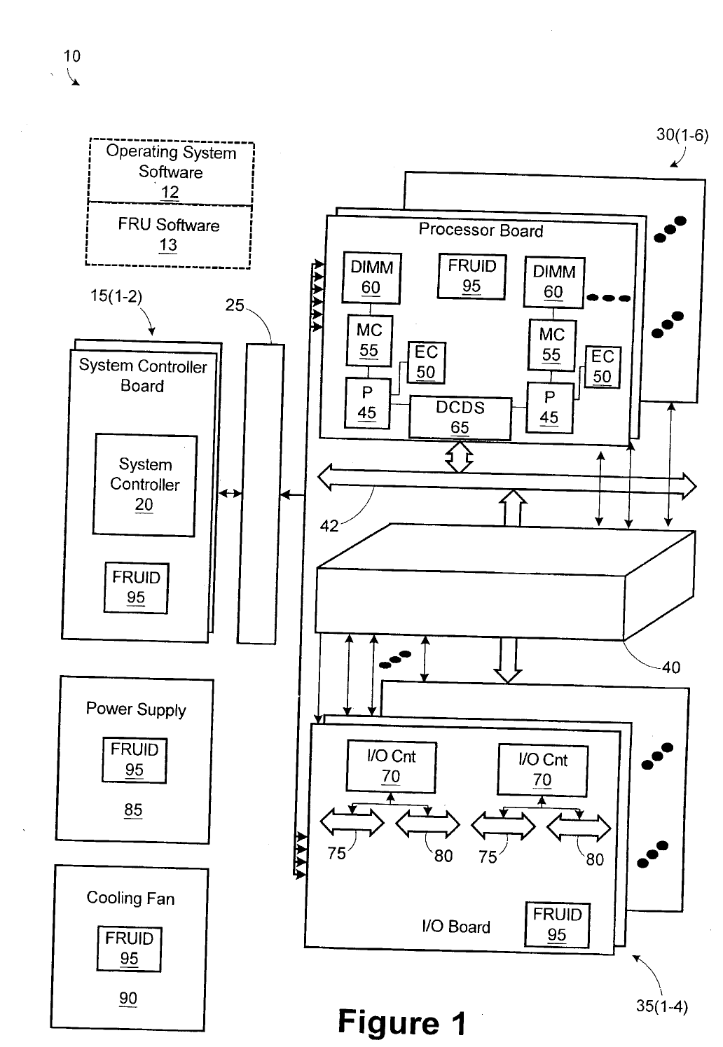

Referring now to FIG. 1, a block diagram of a system 10 in accordance with one embodiment of the present invention is illustrated. In the illustrated embodiment, the system 10 is adapted to run under an operating system 12, such as the Solaris™ operating system offered by Sun Microsystems, Inc. of Palo Alto, Calif.

The system 10, in one embodiment, includes a plurality of system control boards 15(1-2), each including a system controller 20, coupled to a console bus interconnect 25. The system controller 20 may include its own microprocessor and memory resources. The system 10 also includes a plurality of processing boards 30(1-6) and input/output (I/O) boards 35(1-4). The processing boards 30(1-6) and I/O boards 35(1-4) are coupled to a data interconnect 40 and a shared address bus 42. The processing boards 30(1-6) and I/O boards 35(1-4) also interface with the console bus interconnect 25 to allow the system controller 20 access to the processing boards 30(1-6) and I/O boards 35(1-4) without having to rely on the integrity of the primary data interconnect 40 and the shared address bus 42. This alternative connection allows the system controller 20 to operate even when there is a fault preventing main operations from continuing.

In the illustrated embodiment, the system 10 is capable of supporting 6 processing boards 30(1-6) and 4 I/O boards 35(1-4). However, the invention is not limited to such an exemplary implementation, as any number of such resources may be provided. Also, the invention is not limited to the particular architecture of the system 10.

For illustrative purposes, lines are utilized to show various system interconnections, although it should be appreciated that, in other embodiments, the boards 15(1-2), 30(1-6), 35(1-4) may be coupled in any of a variety of ways, including by edge connectors, cables, and/or other available interfaces.

In the illustrated embodiment, the system 10 includes two control boards 15(1-2), one for managing the overall operation of the system 10 and the other for providing redundancy and automatic failover in the event that the other board 15(1-2) fails. Although not so limited, in the illustrated embodiment, the first system control board 15(1) serves as a “main” system control board, while the second system control board 15(2) serves as an alternate hot-swap replaceable system control board.

The main system control board 15(1) is generally responsible for providing system controller resources for the system 10. If failures of the hardware and/or software occur on the main system control board 15(1) or failures on any hardware control path from the main system control board 15(1) to other system devices occur, system controller failover software automatically triggers a failover to the alternative control board 15(2). The alternative system control board 15(2) assumes the role of the main system control board 15(1) and takes over the main system controller responsibilities. To accomplish the transition from the main system control board 15(1) to the alternative system control board 15(2), it may be desirable to replicate the system controller data, configuration, and/or log files on both of the system control boards 15(1-2). During any given moment, generally one of the two system control boards 15(1-2) actively controls the overall operations of the system 10. Accordingly, the term “active system control board,” as utilized hereinafter, may refer to either one of the system control boards 15(1-2), depending on the board that is managing the operations of the system 10 at that moment.

For ease of illustration, the data interconnect 40 is illustrated as a simple bus-like interconnect. However, in an actual implementation the data interconnect 40 is a point-to-point switched interconnect with two levels of repeaters or switches. The first level of repeaters is on the various boards 30(1-6) and 35(1-4), and the second level of repeaters is resident on a centerplane (not shown). The data interconnect 40 is capable of such complex functions as dividing the system into completely isolated partitions and dividing the system into logically isolated domains, allowing hot-plug and unplug of individual boards.

In the illustrated embodiment, each processing board 30(1-6) may include up to four processors 45. Each processor 45 has an associated e-cache 50, memory controller 55 and up to eight dual in-line memory modules (DIMMs) 60. Dual CPU data switches (DCDS) 65 are provided for interfacing the processors 45 with the data interconnect 40. Each pair of processors 45 (i.e., two pairs on each processing board 30(1-6)) share a DCDS 65. Also, in the illustrated embodiment, each I/O board 35(1-4) has two I/O controllers 70, each with one associated 66-MHz peripheral component interface (PCI) bus 75 and one 33-MHz PCI bus 80. The I/O boards 35(1-4) may manage I/O cards, such as peripheral component interface cards and optical cards, that are installed in the system 10.

In the illustrated embodiment, the processors 45 may be UltraSPARC III™ processors also offered by Sun Microsystems, Inc. The processors are symmetric shared-memory multiprocessors implementing the UltraSPARC III protocol. Of course, other processor brands and operating systems 12 may be employed.

Selected modules in the system 10 are designated as field replaceable units (FRUs) and are equipped with FRU identification (FRUID) memories 95. Exemplary FRUs so equipped may include the system controller boards 15(1-2), the processing boards 30(1-6), and the I/O boards 35(1-4). The system 10 may also include other units, such as a power supply 85 (interconnections with other devices not shown), a cooling fan 90, and the like, equipped with FRUIDs 95, depending on the particular embodiment. The system 10 may be configured to allow hot or cold swapping of the field replaceable units. However, some field replaceable units may be required to be serviced and/or replaced at a repair depot.

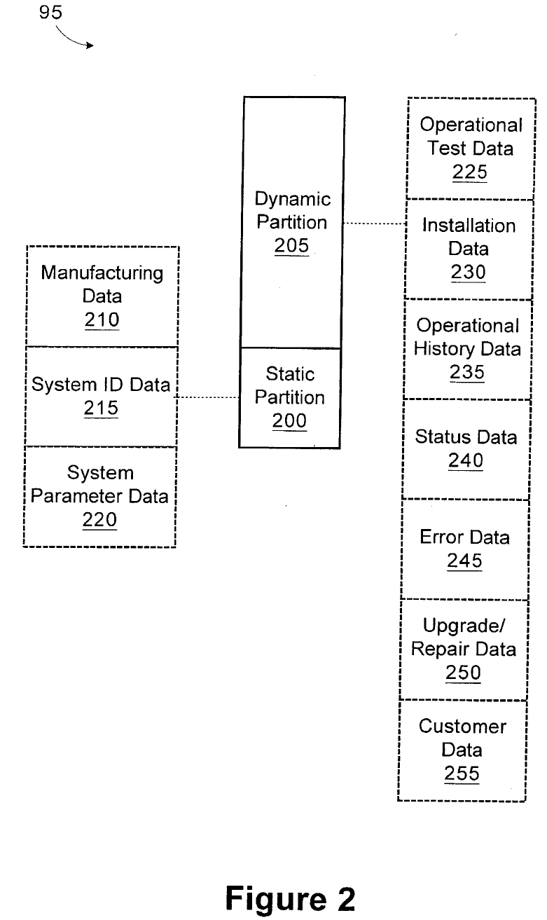

Turning now to FIG. 2, a simplified diagram of the FRUID 95 is provided. In the illustrated embodiment, the FRUID 95 is a serial electrically erasable programmable read-only memory (SEEPROM) and has an 8 Kbyte space to store information about the associated FRU. Of course, other memory types and storage sizes may be used, depending on the particular implementation. The FRUID 95 includes a 2 Kbyte static partition 200 dedicated to store “static” information and a 6 Kbyte dynamic partition 205 to store “dynamic” information.

The static information includes:

Manufacturing Data 210;

System ID Data 215; and

System Parameter Data 220.

The dynamic information includes:

Operational Test Data 225;

Installation Data 230;

Operational History Data 235;

Status Data 240;

Error Data 245;

Upgrade Repair Data 250; and

Customer Data 255.

Some of the benefits derived from the information stored in the FRUID 95 are:

Fatal Error Identification—a fatal error bit may be set on FRU failure and will remain set until after the FRU has been repaired and reset by the repair depot to prevent “accidental” reuse of the failed FRU;

Ease of Tracking Errors—in the event the FRU has been “repaired” and returned to the field, and failed again subsequently with the same or similar failure, the failure log is tagged to insure special attention will be given to the failed FRU;

Trend Analysis—quick identification of certain batch of FRUs with known defects can be done by a serial number embedded into the SEEPROM;

Trend Analysis—quick analysis can be performed by collecting information of specific FRUs, including power-on hours, temperature logs, and the like;

Trend Analysis—quick identification of components from specific vendors on premature failures of certain FRUs; and

Field Change Orders can be applied easily with patches after identifying the range of affected FRU by serial numbers.

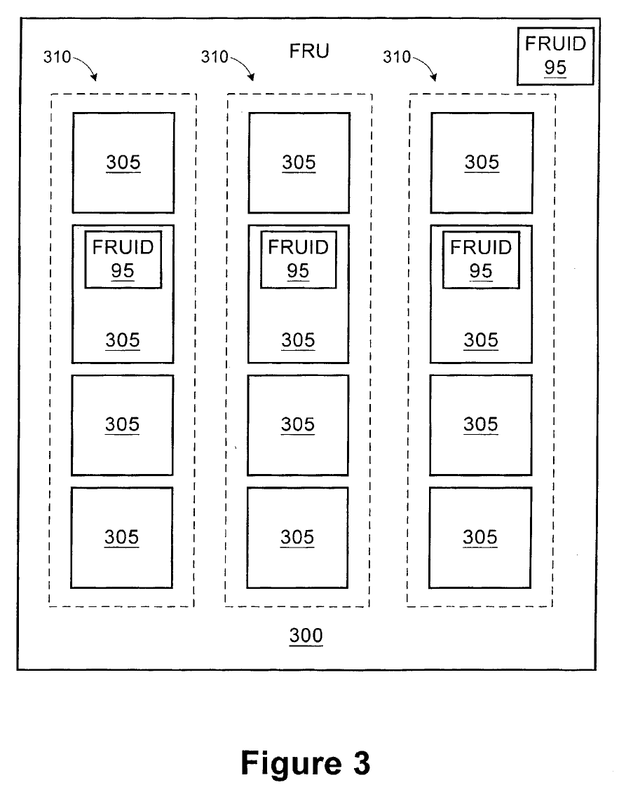

Referring now to FIG. 3, a simplified block diagram of an exemplary FRU 300 having a FRUID 95 is shown. As described above, the FRU 300 may represent one of the system control boards 15(1-2), one of the processing boards 30(1-6), one of the input/output (I/O) boards 35(1-4), the power supply 85, the cooling fan 90, and the like. The FRU 300 includes a plurality of submodules 305. For example, the FRU 300 may be a processing board 30(1-6), and the submodules 305 may be the processors 45, e-caches 50, memory controllers 55, and DIMMs 60. Selected submodules 305 (e.g., the DIMMS 60) may also be themselves field replaceable and have their own FRUIDs 95. The submodules 305 may be organized into groups 310. For example, a processor 45 and its associated e-cache 50, memory controller 55, and DIMMS 60 may be organized into a single group 310.

Information may be stored in the FRUID 95 by the system controller 20, the operating system software 12, or another software application executed by the system 10 (e.g., FRU software 13). Alternatively, information may be stored in the FRUID 95 by a different computer system or interface (not shown) when the FRU 300 is removed for repair, maintenance, or upgrade. The different software and/or hardware entities that may access the FRUID 95 may be generically referred to as controllers.

Returning to FIG. 2, the data stored in the static partition 200 and dynamic partition 210 is now described in greater detail. The particular types of static and dynamic data stored in the FRUID 95 that are detailed herein are intended to be exemplary and non-exhaustive. Additional static and dynamic data may be stored in the FRUID 95 depending on the particular implementation. The information stored in the static partition 200 is typically information that is not expected to change over the service life of the FRU 300, while the dynamic data includes data that is written to the FRUID 95 during its service life. The dynamic data may be written by the manufacturer, a repair depot, or by the system itself during operation of the FRU 300 at a customer installation.

The manufacturing data 210 may include information such as the part number, serial number, date of manufacture, and vendor name. The system ID data 215 may include information such as an ethernet address and a system serial number (i.e., of the system in which the FRU is installed). The system parameter data 220 may include information about the system, such as maximum speed, DIMM speed, maximum power, and the like.

The operational test data 225 provides information about the most recent iteration of tests performed on the FRU 300. The operational test data 225 is typically written during the manufacture of the FRU 300 or while it is being repaired, not while the FRU 300 is in the field. When the FRU 300 is received at a repair depot, the operational test data 225 may be accessed to determine which tests had been previously run on the FRU 300. For each of the possible tests that may be run on the FRU 300, a summary record may be provided that indicates when the test was performed and the revision of the testing procedure used.

The installation data 230 specifies where the FRU 300 has been used, including the system identity and details of the parent FRU (i.e., the FRU in which the current FRU 300 is installed). The installation data 230 may also include geographical data (e.g., latitude, longitude, altitude, country, city or postal address) related to the installation.

The operational history data 235 includes data related to selected parameters monitored during the service life of the FRU 300. For example, the operational history data 235 may include power events and/or temperature data.

Power on and off events are useful in reconstructing the usage of the FRU 300. The power event data could indicate whether the FRU 300 was placed in stock or installed in a system and shipped. The idle time would indicate the shelf life at a stocking facility before use. The time interval between a fatal error and a power on at a repair center could be used to track transit time. The total on time could be used to generate a mean time before failure metric or a mean time before fatal error metric.

Temperature data is useful for analyzing service life and failure rates. Failure rate is often directly dependent on temperature. Various aging mechanisms in the FRU 300 run at temperature controlled rates. Cooling systems are generally designed based on predicted failure rates to provide sufficient cooling to keep actual failure rates at an acceptable level. The temperature history may be used for failed components to determine whether predicted failure rates are accurate. Temperature history can affect failure rate both by aging and by failure mechanisms unrelated to aging. Minimum and maximum operating temperatures are recorded to establish statistical limits for the operating range of the FRU 300. Temperature values are grouped into bins, with each bin having a predetermined range of temperatures. The count of time in each temperature bin defines the temperature history of the operating environment. A last temperature record may be used to approximate the temperature of the FRU 300 when it failed. Temperature data from one FRU 300 may be compared to the histories of other like FRUs to establish behavior patterns. Failure histories may be used to proactively replace temperature-sensitive parts.

The status data 240 records the operational status of the FRU 300 as a whole, including whether it should be configured as part of the system or whether maintenance is required. If maintenance is required, a visible indication may be provided to a user by the system. Exemplary status indications include out-of-service (OOS), maintenance action required (MAR), OK, disabled, faulty, or retired. A human-supplied status bit may be used to indicate that the most recent status was set by human intervention, as opposed to automatically by the system. A partial bit may also be used to indicate while the entire FRU 300 is not OOS, some components on the FRU 300 may be out-of-service or disabled. If the system sees the partial bit checked, it checks individual component status bits to determine which components are OOS or disabled. The status data 240 may also include a failing or predicted failing bit indicating a need for maintenance.

The error data 245 includes soft errors from which the system was able to recover. These soft errors include error checking and correction (ECC) errors that may or may not be correctable. The type of error (e.g., single bit or multiple bits) may also be recorded. A rate-limit algorithm may be used to change the status of the FRU 300 to faulty if more than N errors occur within a FRU-specific time interval, T.

The upgrade/repair data 250 includes the upgrade and repair history of the FRU 300. The repair records include repair detail records, a repair summary record, and an engineering change order (ECO) record. Typically, the repair records are updated at a repair depot when a repair is completed on the FRU 300. The repair information stored on the FRUID 95 may also include the number of times a returned FRU 300 is not diagnosed with a problem. During a repair operation, one or more engineering change orders (ECOs) may be performed on the FRU 300 to upgrade its capability (e.g., upgrade a processor 45) or to fix problems or potential problems identified with the particular FRU 300 model. For example, a firmware change may be implemented or a semiconductor chip (e.g., application specific integrated circuit (ASIC)) may be replaced.

The customer data 255 is generally a free-form field in which the customer may choose to store any type of desired information, such as an asset tag, the customer's name, etc. The customer data 255 may be updated at the customer's discretion.

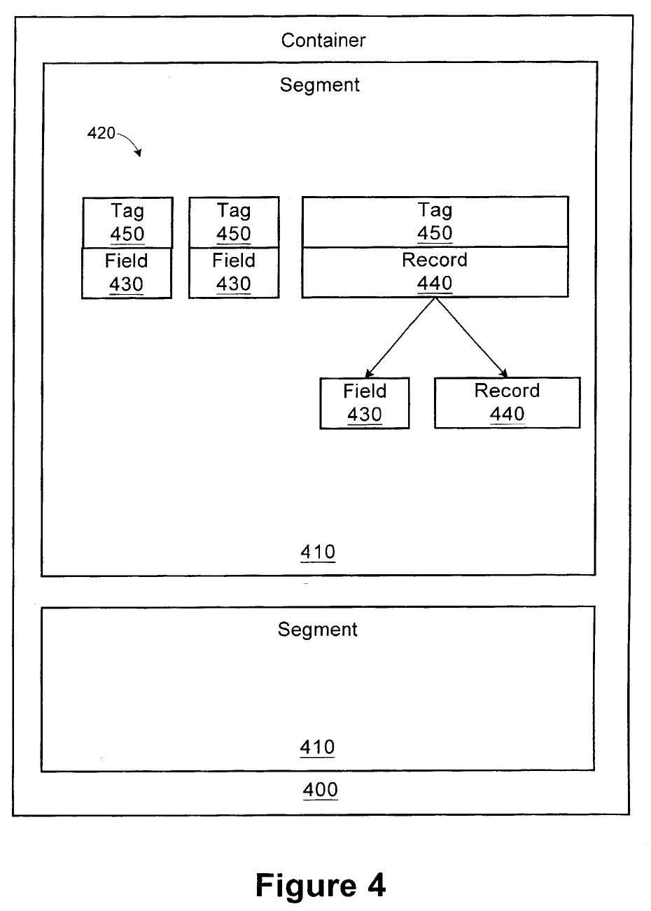

The particular format for storing data in the FRUID 95 is described in greater detail in reference to FIG. 4. In general, the FRUID 95 is referred to as a container 400. The container 400 may include one or more individual memory devices of different types (i.e., sections). The container 400 includes the total storage capacity of the collective devices. The container 400 is subdivided into segments 410. A segment is a continuous part of a container 400 that has the same hardware and software protection characteristics. For example, a particular segment 410 may be read-only, such as the static partition 200 (shown in FIG. 2), and another segment 410 may be read-write such as the dynamic partition 205 (shown in FIG. 2). The level of protection for the various segments 410 may be provided by hardware and/or software. For example, the static partition 200 may have a pin hard-wired to a predetermined state to prevent write access. Each segment 410 within the container 400 has a unique name. In the illustrated embodiment each segment 410 has a two-character name.

The container 400 has an associated container section header stored at the beginning of each hardware-defined section of the container 400 that provides information about the section and its segments 410. The container section header includes the following information:

Header Tag;

Header Version;

Length of this Container ID;

Cyclic Redundancy Check 8 for this Container ID;

Count of the number of segments;

Two-character name of first segment;

Protection flags for first segment;

Offset of first segment (bytes);

Length of first segment (bytes);

Two-character name of second segment;

Protection flags for second segment;

Offset of second segment (bytes);

Length of second segment (bytes); and

additional data for each subsequent segment.

Each non-opaque segment 410 includes a segment trailer including an XOR checksum or CRC-32 checksum, depending on the protection specified for the segment 410 in the Container ID.

A segment 410 may store one or more data elements 420. A data element 420 may include a field 430 or a record 440. A field 430 is a data element 420 with a name and a value. The name identifies the particular field 430 and distinguishes it from other fields 430. The value of the field 430, such as an integer or a string, is stored in the segment 410. Exemplary attributes of a field 430 include:

Name: symbolic name for the field 430.

Data Type: describes the internal storage format of a field value;

Display Type: describes the default way to display the field when human-readable output is desired (e.g., mmddyyyy);

Length: length depending on the data type;

Purgeable (Y/N): can never be purged, or can be purged if space becomes tight in the segment 410;

Relocatable (Y/N): must stay in a fixed position, or can be moved at will.

Enumeration (Y/N): provides for symbolic names for binary and integer items in GUI display (e.g., relates a numerical value to a text name, the text name is displayed, not the value);

Iteration Count: number of iterations for the values of the field 430 (i.e., the default is 0, meaning no iteration); and

Iteration Organization: first-in-first-out (FIFO), circular, linear, or last-in-last-out (LIFO) organization for the values of an iterated field 430.

Records 440 may include an aggregation of one or more data elements 420, such as fields 430 or other records 440. A record 440 has a unique name, but the value of a record 440 lies in the values of its constituent data elements 420. A record 440 is wholly contained in one segment 410. The types of data elements 420 contained within a record 440 are fixed and typically do not change over time. The values of any fields 430 contained in the record 440 may, of course, change over time.

Exemplary attributes of a record 440 include:

Name: the name for the record 440;

Purgeable (Y/N): can never be purged, or can be purged if space becomes tight in the segment 410;

Relocatable (YIN): must stay in a fixed position, or can be moved at will.

Length: number of bytes in the record 440;

Number of Components: number of fields 430 or records 440 that are components of the record 440;

Component Names: names of the component fields and records (The components occupy successive memory positions within the record 440. The length of the record is the sum of the lengths of the subtended elements 420. The sequence of the elements 420 is the sequence which they occupy within the record in the container.);

Iteration Count: number of iterations for the values of the record 440 (i.e., the default is 0, meaning no iteration.); and

Iteration Organization: FIFO, circular, linear, or LIFO organization for the values of an iterated record 440.

Data elements 420 may be stored in a segment 410 using either a fixed or a tagged arrangement. In a segment 410 that specifies a tagged arrangement, fields 430 and records 440 in the container 400 are physically prefaced by tags 450 that contain dense numbers for encapsulating a name, a length, and other information associated with the data element 420. A particular field 430 can be recorded with its own tag 450, or it can be specified as part of a record 440, in which case the record's tag 450 is used to imply the tags for its constituent fields 430. A benefit of a tag arrangement is the ability to achieve forward/backward compatibility. For example, using a tagged data format new data may be added or existing data may be augmented more readily than with other arrangement formats.

In the illustrated embodiment tags 450 range in size from one byte to six bytes, and can describe data that ranges in size from one byte to 4,294,967,295 bytes. The following examples describe the deployment of tags 450 by type of data element 420. At the segment 410 level, every element 420 is tagged. This includes individual fields 430 and/or records 440. These segment-level elements 420 may also be referred to as packets. Data elements 420 below the segment level are not tagged. That is, fields 430 that belong to records 440, and records 440 that are subordinate to higher-level records 440 are not tagged.

In a segment that specifies fixed representation, only fields are recorded in the segment. The locations of the fields 430 are defined by fixed offsets from the start of the segment 420. No field or record tags 450 are recorded. Typically, each field 430 is fixed in length. An unvalued field 430 may be represented with zeroes or blanks. Record definitions may be used for convenience in grouping fields. In a fixed segment, neither fields 430 nor records 440 are readily moveable or changeable.

In the illustrated embodiment, all of the data elements 420 stored in the FRUID 95 use a tagged format. However, it is contemplated that in some alternative embodiments, a fixed data format may be useful for ensuring compatibility with older designs. The use of a tagged data format increases the flexibility of the FRUID 95. The storage location of the data is not fixed. Thus, space does not need to be reserved for data that may or may not be stored in the FRUID 95 during the service life of the FRU 300. The tagged format also allows the contents of the FRUID 95 to be reorganized and/or compacted store the data in a more efficient manner.

In the illustrated embodiment, a segment 410 is identified by a two-digit name, a four byte-descriptor that contains information on the type of encryption (if any) employed, checksum verification, and segment protection. Exemplary information included in a segment descriptor include an encryption bit, which is set if the data in the segment is to be encrypted; an opaque bit, which is set if the segment does not include tagged data; and a fixed bit, which is set if the offset associated with the segment 410 (i.e., from the start of the container 400) is fixed and the segment 410 cannot be moved within the container 400.

Definitions for the fields 430, records 440, and segments 410 are stored within the main memory of the system 10 such that FRU software 13 can access them during its container 400 processing. There is a single definition for each field 430, each record 440, and each segment 410 that includes the unique name of each.

Data elements 420 can be iterated, so that an array of them may be stored. Such an organization may be used to generate a log. For each data element 420 that is iterated, a count is specified during the original creation of the container 400 that delineates the maximum number of iterations that can be written in the container 400. The actual number of iterations stored in the container 400 may be less than the count at any one time, but the space allocated will reflect the specified count. In addition, four bytes of control information are provided for each data element 420 that is iterated. The control information defines one of four organizations for an iterated field. In the illustrated embodiment, the possible organizations are FIFO (default), circular, linear, and LIFO.

In a FIFO organization, reading moves from oldest to newest. Once the queue is full, a new entry replaces the previous newest. A circular organization is FIFO variant where the oldest entry is overwritten when the queue is full. For a queue of size “n”, a circular organization permits retaining the “n” most recent instances. In a linear organization, once the queue is full, no new entries are allowed. In a LIFO arrangement, reading moves from newest to oldest. Once the queue is full, a new entry replaces the previous oldest.

The data type of a field 430 describes the internal format of the field 430. The internal format refers to physical recording of a value for the field 430 in the container 400. The display type describes the external format, which refers to the presentation of the value for the field on GUI or ASCII media. When reading the value of the field 430 from the container 400, the FRU software 13 converts from internal to external format, and when updating or originally entering the value into the container 400, it converts from external format to internal format.

Scalar data types have single values. Enumerated fields use a look-up table for the external format. An iterated field is a scalar field that has multiple, or iterated, values. The scalar types of data fields are subdivided by whether the specified length (or maximum length) counts bits or bytes. For example, a field 3 bytes long would have length 24 if it were a bit-denominated field, and 3 if it were a byte-denominated field. In the illustrated embodiment, binary is the only data type that is bit-denominated.

Exemplary display types are: binary, decimal, hex, octal, time and string. Each data type may be displayed in some subset of these display types. All data types may be displayed in raw format, which is simply a hexadecimal display of the internally stored bytes (bit-denominated fields may be left-padded with zeros if necessary). Bit-denominated fields are counted in bits and align on bits, not bytes.

For determining the length of a data element 420, the following conventions are employed. A segment 410 always starts and ends on a byte boundary. A tag 450 always starts and ends on a byte boundary. A record 440 always starts and ends on a byte boundary. A byte-denominated field always starts and ends on a byte boundary. A lone bit-denominated field, or the first in a sequence of bit-denominated fields, starts on a byte boundary. A bit-denominated field can end in the middle of a byte if its bit-length is not a multiple of eight. A bit-denominated field can begin in the middle of a byte, but only if the preceding data was a bit-denominated field that ended in the middle of a byte. In this case, the field 430 begins on the first bit immediately following the last bit of the previous field. Note that this “bit-packing” of bit-denominated fields 430 occurs within records that have adjacent bit-denominated fields and in iterated bit-denominated fields. An iterated bit-denominated field starts on a byte boundary, but can end in the middle of a byte, subject to the limitations described above for regular bit-denominated fields. All other iterated elements start and end on byte boundaries.

The design of the tags 450 addresses the goal of providing short tags 450 to describe short data and providing longer tags to describe longer data. In the illustrated embodiment, tags 450 are from 1 to 6 bytes long. Each tag 450 contains three fields:

A tag designator indicating the type of tag (in the illustrated embodiment there are 7 types of tags designated by the letters: “A”, “B”, “C”, “D”, “E”, “F”, and

A “dense number” (D), or code, that differentiates a given tag from all other tags of the same type; and

A length field (L) that counts the number of bytes in the tagged item not including the bytes of the tag itself.

Table 1 below illustrates the exemplary tag formats.

TABLE 1
Tag Types

| Tag Type (Length) | |
|---|---|
| Max Bytes/# of Distinct Tags | Format |
| A (1 byte) | 0 \| DDDD \| LLL |
| 7/256 | |
| B (2 bytes) | 10 \| DDDDDDDDDDD \| LLL |
| 7/32,768 | |
| C (2 bytes) | 110 \| DDDDDDDD \| LLLLL |
| 31/32,768 | |
| D (3 bytes) | 1110 \| DDDDDDDDDDDDDDDDD \| LLL |
| 7/131,072 | |
| E (3 bytes) | 11110 \| DDDDDDDDDDDD \| LLLLLLL |
| 127/131,072 | |
| F (4 bytes) | 111110 \| DDDDDDDDDDDDDD \| LLLLLLLLLLLL |
| 4,095/4,294,967,296 | |
| G (6 bytes) | 1111110 \| DDDDDDDDD \| LLLLL . . . LLLLLLLL (32) |
| 4,294,967,295/2⁴⁸ | |

The number of bits of the length field (L) determines how large the tagged item can be. For example, tag type “C” can accommodate fields and records up to 2⁵−1 (i.e., 31) bytes long. Theoretically, the number of distinct tags of a given type is 2 to the power of the total number of bits in the tag divided by the number of tags that have the same length (e.g., for tag type “B”, 2¹⁶/2, or 32,768). In practice, that number is not typically obtained because the length field values do not distribute evenly over the possible values. The maximum number of bytes for the tagged data and the theoretical number of distinct tags are shown above in Table 1.

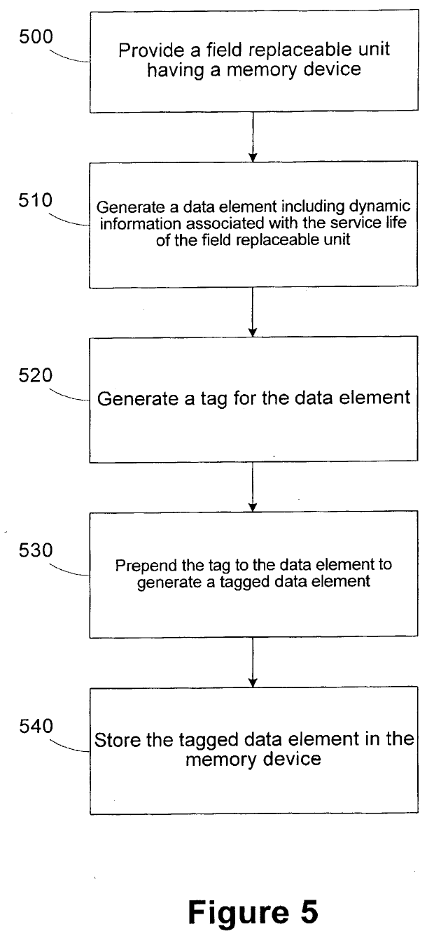

Turning now to FIG. 5, a simplified flow diagram of a method for storing information for a field replaceable unit in accordance with another embodiment of the present invention is provided. In block 500, a field replaceable unit having a memory device is provided. In block 510, a data element including dynamic information associated with the service life of the field replaceable unit is generated. In block 520, a tag is generated for the data element. In block 530, the tag is prepended to the data element to generate a tagged data element. In block 540, the tagged data element is stored in the memory device. The dynamic information is useful for indicating/recording events that have taken place since the manufacture of the field replaceable unit and information related to its field installation. The dynamic information may include installation data, operational history data, status data, error data, upgrade repair data, and customer data.

Storage of the static and dynamic information on the FRUID 95 provides advantages related for record keeping. Much of the important information associated with the service life of the FRU 300 is contained within the FRUID 95, and is thus always available with the device. Information related to operational history, problems, repairs, upgrades, etc. remain retrievable even after the particular installation of the FRU 300 changes. The storage of the static and dynamic information on the FRUID 95 also provides advantages related to fault classification and trending. The information stored on the FRUID 95 may be extracted during a repair activity or while the FRU 300 is installed in the field. The tagged data format provides backward and forward compatibility and allows for reorganization of the data stored in the FRUID 95 for compactness.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method, comprising:
providing a field replaceable unit having a memory device;
generating a first data element including dynamic information associated with a service life of the field replaceable unit;
generating a first tag for the first data element;
prepending the first tag to the first data element to generate a first tagged data element; and
storing the first tagged data element in the memory device.

2. The method of claim 1, further comprising:
generating a second data element including static information associated with the identity of the field replaceable unit;
generating a second tag for the second data element;
prepending the second tag to the second data element; and
storing the second data element in the memory device.

3. The method of claim 1, wherein generating the first data element further comprises generating the first data element including at least one of installation data, operational history data, status data, error data, upgrade/repair data, and customer data.

4. The method of claim 1, wherein generating the second data element further comprises generating the second data element including manufacturing data.

5. The method of claim 1, further comprising:
dividing the memory device into a first segment and a second segment;
storing the first tagged data element in the first segment; and
storing the second tagged data element in the second segment.

6. The method of claim 5, further comprising:
providing a first type of protection for the first segment; and
providing a second type of protection for the second segment.

7. The method of claim 6, wherein providing the first type of protection further comprises providing a read-write type of protection.

8. The method of claim 6, wherein providing the second type of protection further comprises providing a read-only type of protection.

9. The method of claim 1, wherein generating the first tag further comprises generating the first tag including a unique name parameter and a length parameter based on the size of the first data element.

10. The method of claim 9, wherein generating the first tag further comprises generating the first tag including a tag type parameter associated with the tag.

11. The method of claim 1, wherein generating the first data element further comprises generating a field.

12. The method of claim 1, wherein generating the first data element further comprises generating a record.

13. The method of claim 1, wherein generating the first data element further comprises generating a record including a plurality of fields.

14. The method of claim 1, wherein generating the first data element further comprises generating a record including at least one sub-record.

15. The method of claim 1, wherein generating the first data element further comprises generating the first data element including a plurality of sub-data elements without associated tags distinct from the first tag.

16. A computing system comprising a field replaceable unit including a memory device configured to store a first tagged data element, the first tagged data element including a first data element including dynamic information associated with the service life of the field replaceable unit and a first tag associated with the first data element.

17. The system of claim 16, wherein the memory device is further configured to store a second tagged data element, the second tagged data element including a second data element including static information associated with the identity of the field replaceable unit and a second tag associated with the second data element.

18. The system of claim 16, wherein first data element further comprises at least one of installation data, operational history data, status data, error data, upgrade/repair data, and customer data.

19. The system of claim 16, wherein the second data element further comprises manufacturing data.

20. The system of claim 16, wherein the memory device comprises a first segment configured to store the first tagged data element and a second segment configured to store the second tagged data element.

21. The system of claim 20, wherein the first segment has a first type of protection and the second segment has a second type of protection.

22. The system of claim 21, wherein the first type of protection further comprises a read-write type of protection.

23. The system of claim 21, wherein the second type of protection further comprises a read-only type of protection.

24. The system of claim 16, wherein the first tag further comprises a unique name parameter and a length parameter based on the size of the first data element.

25. The system of claim 24, wherein the first tag further comprises a tag type parameter associated with the tag.

26. The system of claim 16, wherein the first data element further comprises a field.

27. The system of claim 16, wherein the first data element further comprises a record.

28. The system of claim 16, wherein the first data element further comprises a record including a plurality of fields.

29. The system of claim 16, wherein the first data element further comprises a record including at least one sub-record.

30. The system of claim 16, wherein the first data element further comprises a plurality of sub-data elements without associated tags distinct from the first tag.

31. A computing system, comprising:
a field replaceable unit including a memory device; and
a controller configured to generate a first data element including dynamic information associated with the service life of the field replaceable unit, generate a first tag for the first data element, prepend the first tag to the first data element to generate a first tagged data element, and store the first tagged data element in the memory device.

32. The system of claim 31, wherein the controller is further configured to generate a second data element including static information associated with the identity of the field replaceable unit, generate a second tag for the second data element, prepend the second tag to the second data element, and store the second data element in the memory device.

33. The system of claim 31, wherein first data element further comprises at least one of installation data, operational history data, status data, error data, upgrade/repair data, and customer data.

34. The system of claim 31, wherein the second data element further comprises manufacturing data.

35. The system of claim 31, wherein the memory device comprises a first segment and a second segment, and the controller is configured to store the first tagged data element in the first segment and store the second tagged data element in the second segment.

36. The system of claim 35, wherein the first segment has a first type of protection and the second segment has a second type of protection.

37. The system of claim 36, wherein the first type of protection further comprises a read-write type of protection.

38. The system of claim 36, wherein the second type of protection further comprises a read-only type of protection.

39. The system of claim 31, wherein the first tag further comprises a unique name parameter and a length parameter based on the size of the first data element.

40. The system of claim 39, wherein the first tag further comprises a tag type parameter associated with the tag.

41. The system of claim 31, wherein the first data element further comprises a field.

42. The system of claim 31, wherein the first data element further comprises a record.

43. The system of claim 31, wherein the first data element further comprises a record including a plurality of fields.

44. The system of claim 31, wherein the first data element further comprises a record including at least one sub-record.

45. The system of claim 31, wherein the first data element further comprises a plurality of sub-data elements without associated tags distinct from the first tag.

46. A computing system, comprising:
a field replaceable unit having a memory device;
means for generating a first data element including dynamic information associated with the service life of the field replaceable unit;
means for generating a first tag for the first data element;
means for prepending the first tag to the first data element to generate a first tagged data element; and
means for storing the first tagged data element in the memory device.
